(19) United States
(12) Patent Application Publication
(10) Pub. No.: US 2025/0289473 A1
(43) Pub. Date: Sep. 18, 2025

(54) VEHICLE SYSTEMS FOR RESPONDING TO SUSPICIOUS ACTIVITY AROUND THE VEHICLE

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); Akimitsu Umekawa, Mountain View, CA (US); Emrah Akin Sisbot, Mountain View, CA (US)

(73) Assignee: TOYOTA MOTOR ENGINEERING & MANUFACTURING NORTH AMERICA, INC., PLANO, TX (US)

(21) Appl. No.: 18/607,221

(22) Filed: Mar. 15, 2024

(51) Int. Cl. B60W 60/00; B60R 25/30; B60R 25/31

(52) U.S. Cl. CPC B60W 60/0016; B60R 25/305; B60R 25/31; B60W 2420/403; B60W 2556/10

(57) ABSTRACT

Systems and methods are provided for responding to suspicious activity occurring at or around a vehicle. The suspicious activity can be identified as occurring in proximity to the vehicle. The vehicle can determine a minimum risk maneuver to mitigate or deter the suspicious activity and perform the first minimum risk maneuver a plurality of times. The vehicle can determine whether the suspicious activity is still occurring and perform the minimum risk maneuver until the suspicious activity is no longer occurring.

### TECHNICAL FIELD

The present disclosure relates generally to mitigating or preventing suspicious activity occurring around a vehicle, and in particular, some implementations may relate to systems employed in response to the presence of suspicious activity.

### DESCRIPTION OF RELATED ART

Suspicious activity can be any undesirable behavior occurring in the surrounding environment or in proximity to a subject vehicle. Suspicious activity can occur relative to the physical/operating aspects or characteristics of the subject vehicle, as well as the user/owner of the subject vehicle. In some embodiments, suspicious activity may include any activity that could indicate a person may be involved in a crime or about to commit a crime. Related behaviors can include, but are not limited to, smashing car windows and taking valuable personal items, lifting the vehicle to grab valuable parts of the vehicle, or any other actions affecting or related to the subject vehicle. Traditional systems can monitor surroundings and notify a driver of suspicious activity. Some vehicles can record video footage of the suspicious activity. Some vehicles can employ deterrent actions in the presence of suspicious activity. Deterrent actions can include audible alarms (i.e., car horns to draw attention to the vehicle) or visual devices such as steering wheel locks, anti-theft decals, flashing lights, and/or window etchings.

### BRIEF SUMMARY OF THE DISCLOSURE

According to various embodiments of the disclosed technology, a method can comprise identifying suspicious activity occurring in proximity to a vehicle; determining a first minimum risk maneuver for the vehicle to mitigate or deter the suspicious activity; performing the first minimum risk maneuver a plurality of times; and determining whether the suspicious activity is still occurring and performing the minimum risk maneuver until the suspicious activity is no longer occurring.

In some embodiments, determining the first minimum risk maneuver comprises determining a plurality of minimum risk maneuvers associated with the suspicious activity; ranking each of the plurality of minimum risk maneuvers based on a type of the suspicious activity and a determined risk associated with the type of the suspicious activity; and selecting a highest ranked minimum risk maneuver.

In some embodiments, the first minimum risk maneuver is selected based on a location of the vehicle.

In some embodiments, determining the first minimum risk maneuver comprises retrieving a plurality of past maneuvers performed and selecting the first minimum risk maneuver from the plurality of past maneuvers.

In some embodiments, the first minimum risk maneuver is performed using the vehicle's autonomous driving systems.

In some embodiments, the method further comprises tracking a location of the suspicious activity and selecting the first minimum risk maneuver based on the location of the suspicious activity.

In some embodiments, determining the first minimum risk maneuver is based on one or more safety metrics associated with the vehicle and the suspicious activity.

In some embodiments, identifying the suspicious activity comprises collecting image data of a person associated with the suspicious activity and determining that the person is not an authorized user of the vehicle based on the image data.

According to various embodiments of the disclosed technology, a vehicle, comprise a processor and a memory coupled to the processor to store instructions. The instructions, when executed by the processor, can cause the processor to identify suspicious activity occurring in proximity to the vehicle; determine a plurality of minimum risk maneuvers for the vehicle to mitigate or deter the suspicious activity; select a random minimum risk maneuver from the plurality of minimum risk maneuvers; perform the random minimum risk maneuver; and determine whether the suspicious activity is still occurring and randomly selecting minimum risk maneuvers to perform until the suspicious activity is no longer occurring.

In some embodiments, the processor is further configured to identify what type of suspicious activity is occurring, wherein the plurality of minimum risk maneuvers are associated with the type of suspicious activity.

In some embodiments, the plurality of minimum risk maneuvers are based on a location of the vehicle.

In some embodiments, determining the plurality of minimum risk maneuvers comprises retrieving a plurality of past maneuvers performed.

In some embodiments, the random minimum risk maneuver is performed using the vehicle's autonomous driving systems.

In some embodiments, the processor is further configured to track a location of the suspicious activity and selecting the plurality of minimum risk maneuvers based on the location of the suspicious activity.

In some embodiments, the processor is further configured to update the plurality of minimum risk maneuvers when the location of the suspicious activity changes.

According to various embodiments of the disclosed technology, a non-transitory machine-readable medium can have instructions stored therein. The instructions, when executed by a processor, can cause the processor identify suspicious activity occurring in proximity to a vehicle; determine a first minimum risk maneuver for the vehicle to mitigate or deter the suspicious activity; perform the first minimum risk maneuver a plurality of times; determine that the suspicious activity is still occurring; determine a second minimum risk maneuver; and perform the second minimum risk maneuver.

In some embodiments, determining the first and second minimum risk maneuvers comprises determining a plurality of minimum risk maneuvers associated with the suspicious activity; ranking each of the plurality of minimum risk maneuvers based on a type of the suspicious activity and a determined risk associated with the type of the suspicious activity; and selecting a first highest ranked and a second highest ranked minimum risk maneuver.

In some embodiments, the first and second minimum risk maneuvers are selected based on a location of the vehicle.

In some embodiments, determining the first and second minimum risk maneuvers comprises retrieving a plurality of past maneuvers performed and selecting the first and second minimum risk maneuvers from the plurality of past maneuvers.

In some embodiments, the instructions further cause the processor to track a location of the suspicious activity and select the first and second minimum risk maneuvers based on the location of the suspicious activity.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example system for detecting and responding to suspicious activity in accordance with one embodiment of the systems and methods described herein.

FIG. 3A illustrates an example architecture executed by the system in FIG. 2 for detecting and responding to suspicious activity.

FIGS. 3B-3C illustrate example minimum risk maneuvers that can be executed by the architecture in FIG. 3A.

FIG. 4 illustrates an example method in accordance with the embodiments described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Deterrent actions including audible alarms and visual devices may deter suspicious activity in some cases, but not others. These deterrent actions do not physically stop a perpetrator of suspicious activity such that the perpetrator is unable to continue with the suspicious activity. At best, some traditional systems can prevent operation of the vehicle such as by locking the driver's unit or dropping/reducing the air pressure in tires. These actions only stop a would-be thief from stealing the actual vehicle but would not prevent the thief from breaking into a vehicle and taking valuable belongings. Some systems can autonomously control vehicles in the presence of risky situations and move away from an approaching risk. However, these risky situations are often limited to potential damage to a vehicle such as an approaching street sweeper. Such systems do not detect suspicious activity, which, e.g., in the context of approaching objects, might suggest an entity approaching as a precursor to, e.g., criminal activity; rather, they determine approaching objects in the path of the subject vehicle and determine that the approaching object will collide with the vehicle, e.g., traffic safety. In summary, traditional systems do not detect suspicious activity and physically move the subject vehicle in response to the suspicious activity.

Embodiments of the systems and methods disclosed herein can provide physical and adaptive deterrents to suspicious activity. Physical action and movement can reduce an intruder's ability to tamper with a subject vehicle. Embodiments can identify the suspicious activity, in particular the type of suspicious activity and specifically how the vehicle is affected by the suspicious activity. This analysis enables the vehicle to perform tailored physical maneuvers to mitigate or deter the suspicious activity. Example maneuvers can include moving the vehicle back and forth, turning the vehicle, or any other maneuver that causes the vehicle to leave or alter its current location. These maneuvers can be tailored to the suspicious activity to be minimum risk. Here, minimum risk refers to potential damage to the vehicle, the intruder, or any other negative consequences of moving the vehicle. In other words, embodiments seek to minimize potential damage to the vehicle, the intruder, or any other negative consequences of moving the vehicle (vis-à-vis minimum risk maneuvers) while still mitigating/deterring the suspicious activity. Minimum risk maneuvers can be determined in various ways. In some embodiments, one or more machine learning models can assess the severity or potential negative impact of detected suspicious activity. When suspicious activity is detected, the system can determine the severity of the activity and evaluate possible responses. These possible responses can be attributed a risk and the system can select the response with a minimum risk. In other embodiments, environmental constraints can limit or determine the set of possible responses. For example, if suspicious activity is detected while the vehicle is parked, the vehicle can sense the amount of movement possible within the parking spot (i.e., avoiding neighboring parked cars/pillars/whatever) and determine a minimum risk maneuver based on the constraints. Maneuvers can be performed multiple times or can be updated and changed in real time in response to any change in suspicious activity. The system can dynamically monitor and address the situation until the suspicious activity is no longer occurring/there is no longer a threat.

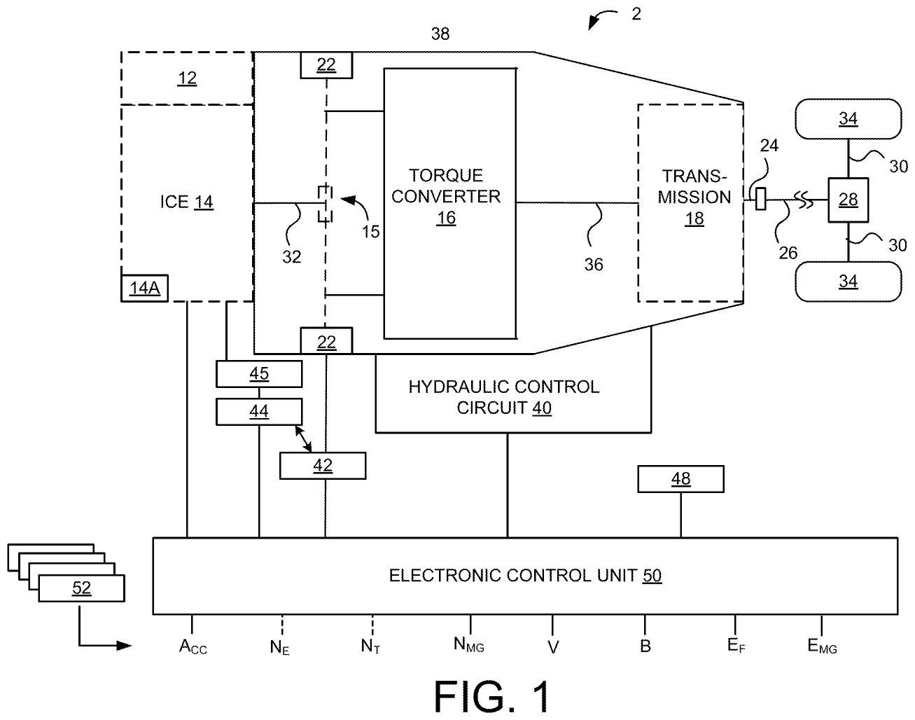

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for mitigating suspicious activity can be implemented in other types of vehicles including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium-ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium-ion batteries, lead acid batteries, nickel cadmium batteries, lithium-ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

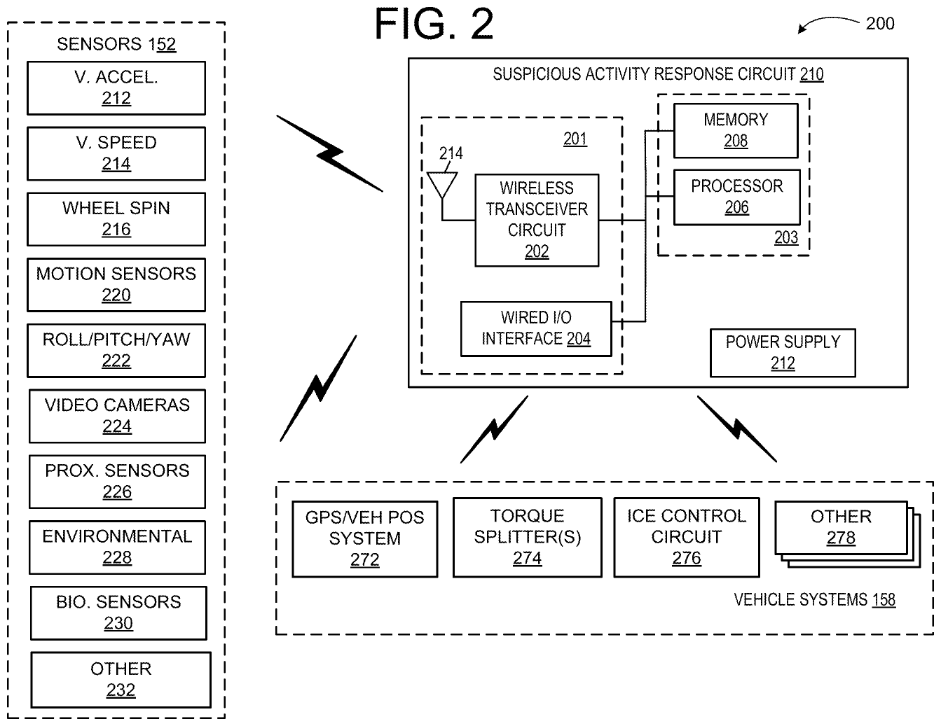

FIG. 2 illustrates an example architecture for detecting and responding to suspicious activity in accordance with one embodiment of the systems and methods described herein. In some embodiments, suspicious activity response system 200 can be implemented in-vehicle. Referring now to FIG. 2, in this example, suspicious activity response system 200 includes a suspicious activity response circuit 210, a plurality of sensors 152 and a plurality of vehicle systems 158.

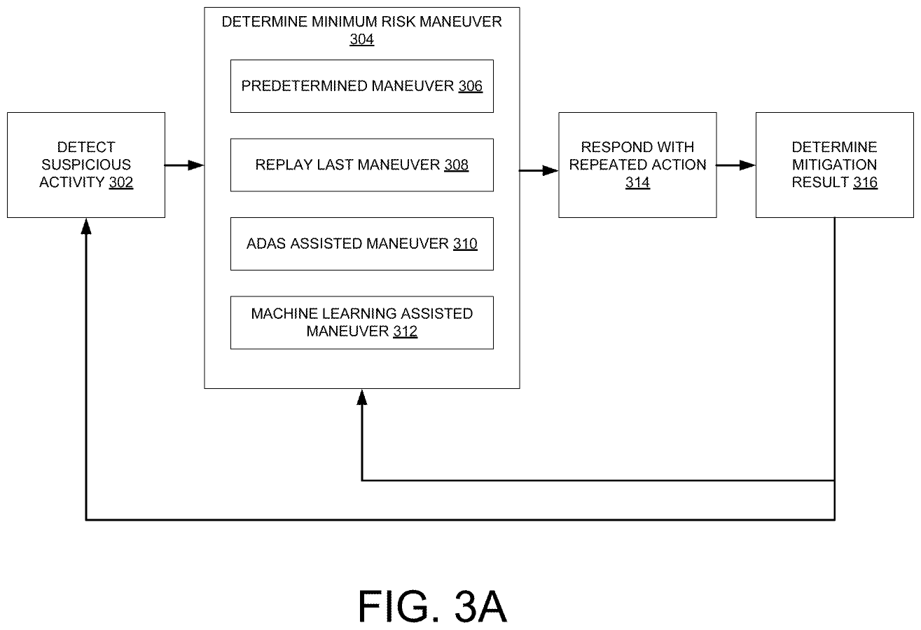

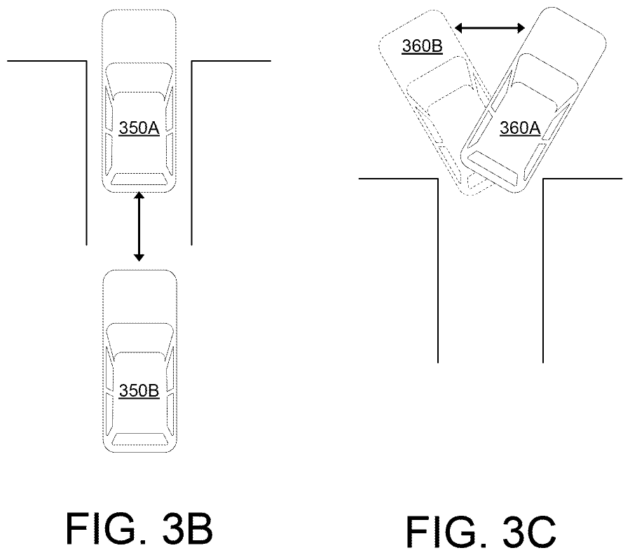

Sensors 152 and vehicle systems 158 can communicate with suspicious activity response circuit 210 via a wired or wireless communication interface. Although sensors 152 and vehicle systems 158 are depicted as communicating with suspicious activity response circuit 210, they can also communicate with each other as well as with other vehicle systems. In embodiments where suspicious activity response circuit 210 is implemented in-vehicle, suspicious activity response circuit 210 can be implemented as an ECU or as part of an ECU such as, for example electronic control unit 50. Suspicious activity response circuit 210 can execute the architecture described below in FIGS. 3A-C and communicate back to sensors 152 and vehicle systems 158.

Suspicious activity response circuit 210 in this example includes a communication circuit 201, a decision circuit 203 (including a processor 206 and memory 208 in this example) and a power supply 212. Components of suspicious activity response circuit 210 are illustrated as communicating with each other via a data bus, although other communication in interfaces can be included. Suspicious activity response circuit 210 can detect suspicious activity occurring around the vehicle. Decision circuit 203 can determine a minimum risk maneuver for the vehicle to execute, as described further below. Suspicious activity response circuit 210 can communicate with vehicle systems 158 to perform the minimum risk maneuver. Suspicious activity response circuit 210 can also communicate with sensors 152 to update the minimum risk maneuver as necessary. Decision circuit 203 can execute the architecture described below in FIGS. 3A-3C until the suspicious activity is no longer detected.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory and may be configured to store data and other information as well as operational instructions that may be used by the processor 206 to suspicious activity response circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up suspicious activity response circuit 210.

Communication circuit 201 either or both a wireless transceiver circuit 202 with an associated antenna 205 and a wired I/O interface 204 with an associated hardwired data port (not illustrated). Communication circuit 201 can provide for V2X and/or V2V communications capabilities, allowing suspicious activity response circuit 210 to communicate with edge devices, such as roadside unit/equipment (RSU/RSE), network cloud servers and cloud-based databases, and/or other vehicles via a network. For example, V2X communication capabilities allows suspicious activity response circuit 210 to communicate with edge/cloud devices, roadside infrastructure (e.g., such as roadside equipment/roadside unit, which may be a vehicle-to-infrastructure (V2I)-enabled streetlight or cameras, for example), etc. Local suspicious activity response circuit 210 may also communicate with other connected vehicles over vehicle-to-vehicle (V2V) communications.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with suspicious activity response circuit 210 can include either or both wired and wireless communications circuits 201. Wireless transceiver circuit 202 can include a transmitter and a receiver (not shown) to allow wireless communications via any of a number of communication protocols such as, for example, WiFi®, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by suspicious activity response circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH₂, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the suspicious activity response system 200 is implemented. In the illustrated example, sensors 152 include vehicle acceleration sensors 212, vehicle speed sensors 214, wheelspin sensors 216 (e.g., one for each wheel), motion sensors 220 (configured to detect movement or activity in proximity to the vehicle), accelerometers such as a 3-axis accelerometer 222 to detect roll, pitch and yaw of the vehicle, vehicle cameras 224 (positioned to record image or video data on any or all sides of the vehicle), proximity sensors 226 (to detect near or approaching objects), environmental sensors 228 (e.g., to detect salinity or other environmental conditions), biometric sensors 230 (to detect biometric features such as facial recognition, eye movement, etc.). Additional sensors 232 can also be included as may be appropriate for a given implementation of suspicious activity response system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); and other vehicle systems 278.

Communication circuit 201 can be used to transmit and receive information between suspicious activity response circuit 210 and sensors 152, and suspicious activity response circuit 210 and vehicle systems 158. Also, sensors 152 may communicate with vehicle systems 158 directly or indirectly (e.g., via communication circuit 201 or otherwise).

FIG. 3A illustrates an example architecture to be employed by vehicle systems to detect and respond to suspicious activity. At block 302, the system can detect suspicious activity. As described above, suspicious activity can comprise any undesirable behavior occurring relative to the physical/operating aspects or characteristics of the subject vehicle, as well as the user/owner of the subject vehicle. Vehicles can employ internal or external sensors to detect this suspicious activity. For example, a camera sensor may be mounted to the vehicle to detect intruders looking inside the vehicle. In some embodiments, a system (e.g., suspicious activity response circuit 210) can compare received data from sensors (e.g., sensors 152) to a database of known data indicating suspicious activity. The subject vehicle (e.g., with suspicious activity response circuit 210) can determine that the sensor data collected is sufficiently similar to that of known data indicating suspicious activity. Based on the similarity, suspicious activity response circuit 210 can receive the information on the corresponding suspicious activity type. This database may comprise information such as breaking/entering, removing vehicle parts, etc. The database may also tag relevant sensor data based on the type of environment, the user of the vehicle, or any other indicators that the activity is abnormal. For instance, the database may comprise proximity or motion sensor data related to activity in a parking garage. In cases where there is a vehicle parked next to the subject vehicle, a person being close to the subject vehicle may be trying to enter his/her parked adjacent vehicle. On the other hand, if there are no cars parked beside the subject vehicle, a person approaching the subject vehicle may indicate suspicious activity. Proximity sensors can determine whether a vehicle is parked besides the subject vehicle, so that the right comparison with the database is made. In addition or alternatively, an adjacent parked/moving vehicle can detect the suspicious activity and trigger the ego vehicle system. The ego vehicle can accordingly respond to the suspicious activity.

In some embodiments, the database may comprise information on standard activity. If the collected sensor data is sufficiently dissimilar to that in the database, the suspicious activity response circuit 210 can determine that the behavior is then suspicious. Suspicious activity response circuit 210 can store thresholds related to similarity or dissimilarity (e.g., at memory 208) and can communicate with the database to retrieve known data. Processor 206 can execute block 302 to detect the suspicious activity. In other embodiments, the subject vehicle can employ one or more machine learning models trained to detect types of suspicious activity from sensor data. Suspicious activity response circuit 210 can input the collected sensor data into these machine learning models and receive results indicating whether suspicious activity is occurring and/or the type of activity. These machine learning models can be trained using a database of known data associated with suspicious activity (as described above). One or more vehicles can detect and/or respond to suspicious activity. In some embodiments, multiple vehicles may sense suspicious activity, may identify the affected vehicle and the type of suspicious activity. In such embodiments, the vehicles can individually evaluate sensor data to determine if there's suspicious activity. If two or more vehicles identify similar or the same suspicious activity, the group of vehicles can determine that there is suspicious activity. Alternatively, the subject vehicle can on its own detect the suspicious activity.

In some embodiments, the vehicle can request a face scan of person surrounding the vehicle using cameras and/or biometric sensors. These sensors can collect image and/or video data and transmit the data to suspicious activity response circuit 210. Suspicious activity response circuit 210 can compare the collected images to stored images of authorized users of the subject vehicle and/or perform facial recognition. If an authorized user is detected, the vehicle may automatically determine that there is no suspicious activity. Alternatively, the face scan and associated image data can be used to determine that the person is not an authorized user of the vehicle. This can in turn trigger the vehicle's response system. The system may decide other “exceptions” that do not require triggering a system response. In some embodiments, the driver can create a filter list and set cases as exceptions (e.g., towing vehicles, family members, etc.). This filter list can be stored in memory 208. Suspicious activity response circuit 210 may communicate with a database as described above to determine if collected sensor data meets any of the listed exceptions. The database can attribute known sensor data to these exceptions so that when similarities are determined, suspicious activity response circuit 210 can determine that the collected sensor data meets an exception listed on the filter list. Any systems or sensors can be employed to detect the suspicious activity and/or exception. The employed response can be tailored to the type of suspicious activity. That is, suspicious activity response circuit 210 may store one or more maneuvers in memory 208 corresponding to types of suspicious activity. Once circuit 210 detects and determines that there's suspicious activity, it can communicate these specific maneuvers to vehicle systems 158 and sensors 152 so that an appropriate maneuver can be used. The vehicle or group of vehicles can continuously monitor the suspicious activity until the suspicious activity either ends or is successfully deterred.

At block 304, the system can determine a minimum risk maneuver to respond to the suspicious activity. As described above, a minimum risk maneuver can refer to any physical maneuver of the vehicle that takes into account any risks or danger to the subject vehicle and/or the intruder. In some embodiments, a remote server can make these determinations and share selected maneuvers with the subject vehicle or multiple vehicles to execute. There can be one or more minimum risk maneuvers associated with suspicious activity. In cases where there are multiple available maneuvers, the vehicle can execute one or more of the maneuvers in any order. In such embodiments, the order may be based on a ranking of the relative risk. In other embodiments, the order may be randomized. In some embodiments, the vehicle may execute a subset of the one or more maneuvers. In other embodiments, the vehicle may perform randomized or set patterns of the maneuvers in the subset. Blocks 306-312 illustrate different ways that the system can determine minimum risk maneuvers.

Predetermined maneuvers 306 can refer to maneuvers that are known/have been observed in other contexts/other scenarios/with other vehicles and are associated with the suspicious activity. As described above, the subject vehicle (e.g., with suspicious activity response circuit 210) can determine that the sensor data collected is sufficiently similar to that of known data indicating suspicious activity from a database. Based on the similarity, suspicious activity response circuit 210 can receive the information on the corresponding suspicious activity type as the known data can be tagged with information indicating the type of suspicious activity, the environment, the affected vehicle, etc. Predetermined maneuvers 306 can be selected based on the type of suspicious activity. In some embodiments, predetermined maneuvers 306 can also be selected based on the location of the vehicle, suspicious activity, and/or intruder. As described above, suspicious activity response circuit 210 may determine the location based on motion sensors, proximity sensors, or cameras. For instance, if a vehicle is located in a parking space, an available maneuver may be to pull in and out of the parking space. As another example, if a vehicle is located on a driveway, the maneuvers may limit the vehicle's range of motion to the driveway.

At block 308, the system can replay the last maneuver used. Here, the last maneuver used can refer to the last maneuver used in response to the current event of suspicious activity. In other embodiments, the last maneuver can refer to the last maneuver performed in a similar location or situation. For instance, the vehicle can recall the last maneuver performed when parked in a parking space. Using the previous examples, the last maneuver may be pulling in and out of the parking space. The system can recall this motion and execute the same maneuver or a modified version of the maneuver to accommodate any differences in the location (i.e., any difference in the size of the parking space, etc.).

Advanced driver assistance systems (ADAS) assisted maneuvering 310 can refer to any available ADAS system. Examples can include advanced parking features, object detection, lane or road line monitoring, or any other ADAS feature to assist vehicle movement. As described above, the vehicle can detect suspicious activity and the corresponding type using collected sensor data. As described above, information corresponding to the detected suspicious activity can also comprise information on the environment, risk associated with available solutions, feasible ADAS features, etc. The vehicle (e.g., suspicious activity response circuit 210) can transmit control signals and/or instructions to the ADAS. In some embodiments, the type of suspicious activity can indicate what ADAS features to use. In other embodiments, environmental data can indicate available ADAS features (e.g., where the vehicle can move based on objects or vehicles in proximity.) The vehicle can use ADAS assisted maneuvering 310 to maneuver the vehicle into and out of a parking space, traverse a driveway, navigate street parking, and/or navigate any location of the vehicle.

Machine learning assisted maneuvers 312 can refer to any algorithms used to analyze the vehicle's environment and determine a least risky maneuver. In some embodiments, the vehicle can employ machine learning algorithms. In other embodiments, a remote server can execute the machine learning algorithm and transmit results to the subject vehicles. In some embodiments, the vehicle can initiate remote server assistance or remote driving, such that the remote server can guide the vehicle to perform a repeated maneuver or a varying set of maneuvers.

The minimum risk maneuver can be dynamically updated as the situation evolves. For instance, intruders may change locations or move around the vehicle. In this case, the vehicle can update the minimum risk maneuver based on the location of the intruders and dynamically change it according to perceived risk (e.g., collision risk) or safety metrics (e.g., time headway). For example, the intruder may be located under the car trying to remove vehicle parts. In this case, the vehicle can predict the position of the person (e.g., use the side camera to detect the person), and the position could be a parameter in determining the minimum risk maneuver. As another example, the vehicle may be connected to a charging cable (e.g., electric/hybrid vehicles). The standard length of the charging cable could be a parameter in determining the minimum risk maneuver. As an intruder moves around the vehicle, the vehicle may employ maneuvers that take into account the length of the charging cable. In some embodiments, the vehicle may comprise a mechanism to automatically unplug the charging cable before applying a physical maneuver.

At block 314, the vehicle can respond to the suspicious activity with repeated action based on the selected/determined minimum risk maneuvers. The minimum risk maneuvers may include information on what vehicle systems to employ. The vehicle (e.g., suspicious activity response circuit 210) can communicate this information to vehicle systems 158 to effectuate the maneuver. In some embodiments, repeated action may be repeating the same maneuver. If there is more than one available maneuver, the vehicle can randomly select a maneuver, may execute maneuvers in a pattern, may repeat one at a time, and/or use any other or combination of the maneuvers. In some embodiments, the vehicle can move in conjunction with other deterrent actions. For example, while moving, the vehicle may flash headlights, may sound a car alarm, may record video, or any other deterrent.

At block 316 the system can evaluate the results of executing these maneuvers. In some embodiments, the vehicle will execute maneuvers until the suspicious activity is mitigated or no longer occurring. In some embodiments, the vehicle can evaluate the environment using sensor data to determine a result of executing the maneuvers. In some embodiments, if the suspicious activity is still occurring after a time interval, the system may switch maneuvers, may notify authorities, or may otherwise alter actions in response to the continued suspicious activity.

FIG. 3B and 3C illustrate example maneuvers that can be executed when the vehicle is located in a parking space. At FIG. 3B, vehicle 350 may move from position 350A to 350B back and forth. In some embodiments, vehicle 350 may be limited based on the size of the parking space. In some embodiments, vehicle 350 may pull entirely out of the parking space. Vehicle 350 may employ turns while moving depending on the space available, the surrounding vehicles, etc. At FIG. 3C, vehicle 360 can turn from position 360A to 360B. In some embodiments, vehicle 360 may pull out of the parking space into position 360A, pull back into the parking spot, and pull out into position 360B. As with FIG. 3B, in some embodiments, vehicle 360 may be limited based on the size of the parking space. In some embodiments, vehicle 360 may pull entirely out of the parking space or partially out of the parking space.

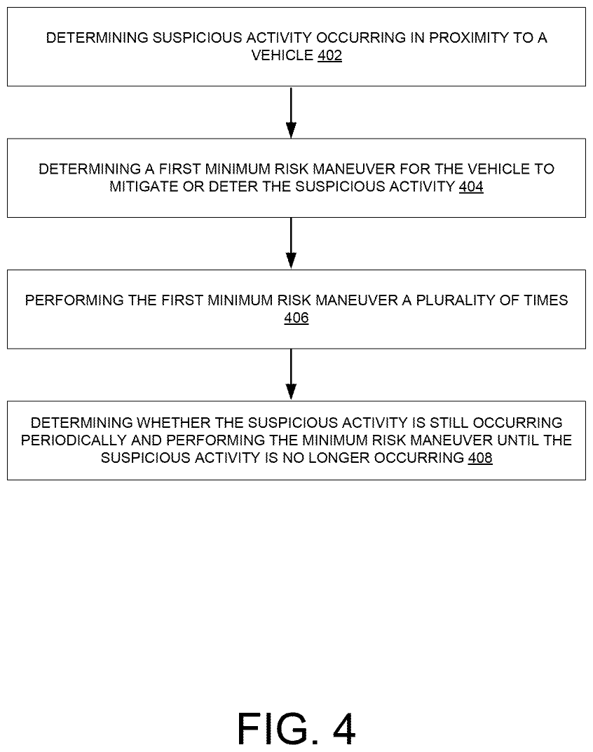

FIG. 4 illustrates an example method in accordance with the embodiment described above. At block 402, the system can determine suspicious activity occurring in proximity to a vehicle. As described above, one or more vehicles can employ internal or external sensors to detect this suspicious activity. The vehicles may identify the affected vehicle and the type of suspicious activity. In some embodiments, the system may decide “exceptions” that do not require triggering a system response. In some embodiments, the driver can create a filter list and set cases as exceptions (e.g., towing vehicles, family members, police looking inside the car etc.). Any systems or sensors can be employed to detect the suspicious activity. The employed response can be tailored to the type of suspicious activity, meaning sensors and vehicle systems can communicate the type of suspicious activity to the system so that an appropriate maneuver can be used. The vehicle or group of vehicles can continuously monitor the suspicious activity until the suspicious activity either ends or is successfully deterred.

At block 404, the system can determine a first minimum risk maneuver for one or more vehicles to mitigate or deter the suspicious activity. As described above, a minimum risk maneuver can refer to any physical maneuver of the vehicle that takes into account any risks or danger to the subject vehicle and/or the intruder. In some embodiments, a remote server can make these determinations and share selected maneuvers with the subject vehicle or multiple vehicles to execute. There can be one or more minimum risk maneuvers associated with suspicious activity. In cases where there are multiple available maneuvers, the vehicle can execute one or more of the maneuvers in any order. In some embodiments, if there are a plurality of minimum risk maneuvers associated with the suspicious activity, the system can select the first minimum risk maneuver. In some embodiments, the system can retrieve a plurality of past maneuvers performed and select a minimum risk maneuver from the plurality of past maneuvers.

At block 406, the system can perform the first minimum risk maneuver a plurality of times. In some embodiments, the vehicle can repeat the same maneuver. In some embodiments, there may be more than one available maneuver. In that case, the vehicle can randomly select a maneuver, may execute maneuvers in a pattern, may repeat one at a time, and/or use any other or combination of the maneuvers. In some embodiments, the vehicle can move in conjunction with other deterrent actions.

At block 408, the system can determine whether the suspicious activity is still occurring periodically and perform the minimum risk maneuver until the suspicious activity is no longer occurring. In some embodiments, the vehicle will execute maneuvers until the suspicious activity is mitigated or no longer occurring. In some embodiments, the vehicle can evaluate the environment using sensor data to determine a result of executing the maneuvers. In some embodiments, if the suspicious activity is still occurring after a time interval, the system may switch maneuvers, may notify authorities, or may otherwise alter actions in response to the continued suspicious activity.

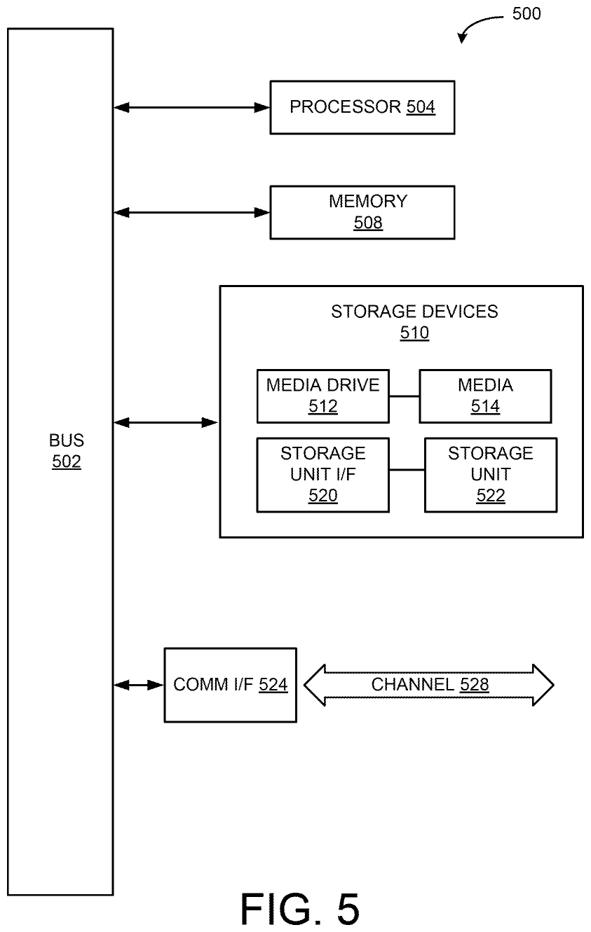

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or another interface). Other examples include a communications port (such as for example, a USB port, IR port, RS232 port Bluetooth® interface, or other port), or another communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
identifying suspicious activity occurring in proximity to a vehicle;
determining a first minimum risk maneuver for the vehicle to mitigate or deter the suspicious activity;
performing the first minimum risk maneuver a plurality of times; and
determining whether the suspicious activity is still occurring and performing the minimum risk maneuver until the suspicious activity is no longer occurring.

2. The method of claim 1, wherein determining the first minimum risk maneuver comprises:
determining a plurality of minimum risk maneuvers associated with the suspicious activity;
ranking each of the plurality of minimum risk maneuvers based on a type of the suspicious activity and a determined risk associated with the type of the suspicious activity; and
selecting a highest ranked minimum risk maneuver.

3. The method of claim 2, wherein the first minimum risk maneuver is selected based on a location of the vehicle.

4. The method of claim 1, wherein determining the first minimum risk maneuver comprises retrieving a plurality of past maneuvers performed and selecting the first minimum risk maneuver from the plurality of past maneuvers.

5. The method of claim 1, wherein the first minimum risk maneuver is performed using the vehicle's autonomous driving systems.

6. The method of claim 1, further comprising tracking a location of the suspicious activity and selecting the first minimum risk maneuver based on the location of the suspicious activity.

7. The method of claim 1, wherein determining the first minimum risk maneuver is based on one or more safety metrics associated with the vehicle and the suspicious activity.

8. The method of claim 1, wherein identifying the suspicious activity comprises:
collecting image data of a person associated with the suspicious activity; and
determining that the person is not an authorized user of the vehicle based on the image data.

9. A vehicle, comprising:
a processor; and
a memory coupled to the processor to store instructions, which when executed by the processor, cause the processor to:
identify suspicious activity occurring in proximity to the vehicle;
determine a plurality of minimum risk maneuvers for the vehicle to mitigate or deter the suspicious activity;
select a random minimum risk maneuver from the plurality of minimum risk maneuvers;
perform the random minimum risk maneuver; and
determine whether the suspicious activity is still occurring and randomly selecting minimum risk maneuvers to perform until the suspicious activity is no longer occurring.

10. The vehicle of claim 9, wherein the processor is further configured to identify what type of suspicious activity is occurring, wherein the plurality of minimum risk maneuvers are associated with the type of suspicious activity.

11. The vehicle of claim 9, wherein the plurality of minimum risk maneuvers are based on a location of the vehicle.

12. The vehicle of claim 9, wherein determining the plurality of minimum risk maneuvers comprises retrieving a plurality of past maneuvers performed.

13. The vehicle of claim 9, wherein the random minimum risk maneuver is performed using the vehicle's autonomous driving systems.

14. The vehicle of claim 9, wherein the processor is further configured to track a location of the suspicious activity and selecting the plurality of minimum risk maneuvers based on the location of the suspicious activity.

15. The vehicle of claim 14, wherein the processor is further configured to update the plurality of minimum risk maneuvers when the location of the suspicious activity changes.

16. A non-transitory machine-readable medium having instructions stored therein, which when executed by a processor, cause the processor:
identify suspicious activity occurring in proximity to a vehicle;
determine a first minimum risk maneuver for the vehicle to mitigate or deter the suspicious activity;
perform the first minimum risk maneuver a plurality of times;
determine that the suspicious activity is still occurring;
determine a second minimum risk maneuver; and
perform the second minimum risk maneuver.

17. The non-transitory machine-readable medium of claim 16, wherein determining the first and second minimum risk maneuvers comprises:
determining a plurality of minimum risk maneuvers associated with the suspicious activity;
ranking each of the plurality of minimum risk maneuvers based on a type of the suspicious activity and a determined risk associated with the type of the suspicious activity; and
selecting a first highest ranked and a second highest ranked minimum risk maneuver.

18. The non-transitory machine-readable medium of claim 17, wherein the first and second minimum risk maneuvers are selected based on a location of the vehicle.

19. The non-transitory machine-readable medium of claim 16, wherein determining the first and second minimum risk maneuvers comprises retrieving a plurality of past maneuvers performed and selecting the first and second minimum risk maneuvers from the plurality of past maneuvers.

20. The non-transitory machine-readable medium of claim 16, wherein the instructions further cause the processor to track a location of the suspicious activity and select the first and second minimum risk maneuvers based on the location of the suspicious activity.
